(19) United States
(12) Patent Application Publication
(10) Pub. No.: US 2011/0116008 A1
(43) Pub. Date: May 19, 2011

(54) ILLUMINATION DEVICE AND LIQUID CRYSTAL DISPLAY DEVICE

(75) Inventors: Yuhsaku Ajichi, Osaka-shi (JP); Takeshi Masuda, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 12/999,066

(22) PCT Filed: Apr. 15, 2009
(86) PCT No.: PCT/JP2009/057590

§ 371 Date: Dec. 15, 2010

(30) Foreign Application Priority Data
Jul. 11, 2008 (JP) 2008-181757

(51) Int. Cl. G02F 1/1335; F21V 8/00

(52) U.S. Cl. 349/61; 362/617

(57) ABSTRACT

A backlight (illumination device) (22) of the present invention includes: a plurality of light sources (25) which emit light beams of two or more different colors; and a plurality of light guides (27) each of which mixes colored light beams emitted from the light sources and then converts the colored light beams thus mixed into surface emission, wherein the plurality of light guides (27) are arranged so as not to overlap one another, the plurality of light sources (25) are aligned in a given order along first end parts of each of the light guides, and scatterers (scattering means) (34) for scattering light beams are provided on side surfaces of second end parts (27b) of each of the light guide, which second end parts face a direction where the light sources are aligned (d1).

### TECHNICAL FIELD

The present invention relates to: an illumination device that includes a plurality of light sources and light guides each of which converts light from the light sources to surface emission; and a liquid crystal display device including the illumination device.

### BACKGROUND ART

A liquid crystal display device has an illumination device provided on a front or back surface of a liquid crystal panel. A light source provided on the back surface of a liquid crystal panel is generally referred to as a backlight. The backlight is classified into the following two types: a direct type backlight having a light source provided directly below a liquid crystal panel; and an edge-light type backlight having a light source disposed on an edge surface of a light guide that guides light to thereby obtain a planar light source.

In both of these two types, cold-cathode fluorescent tubes are generally used as their light sources. However, in order to address environmental problems, etc. there have been recently developed illumination devices using mercury-free light-emitting diodes as light sources (for example, see Patent Literatures 1 through 5).

Cases where white illumination devices are obtained by using light-emitting diodes as light sources are categorized into (i) a case where a white illumination device is obtained by using white light-emitting diodes each of which is constituted by a combination of a blue light-emitting diode and a yellow light-emitting fluorescent material and (ii) a case where a white illumination device is obtained by disposing plural sets of monochromatic light-emitting diodes that respectively emit light beams of different colors, such as red, green, and blue and by mixing the colored light beams emitted from the light-emitting diodes. In recent years, attention has been focused on a backlight in which monochromatic light-emitting diodes that respectively emit light beams of red, green, and blue are used in combination because such a backlight is capable of providing a wide range of color reproduction.

Examples of the direct type backlight include a backlight in which red, green, and blue monochromatic light-emitting diodes are used in combination. Such a backlight has been mass-produced for use in a liquid crystal display device. Such a set of primary color light-emitting diode in which red, green, and blue light-emitting diodes are used in combination needs to obtain white light by mixing colored light beams emitted from the respective light-emitting diodes. For this purpose, a diffusing plate for diffusing light emitted from the light-emitting diodes is provided, or a liquid crystal panel, which is to be irradiated with light, is provided at some distance from the light-emitting diodes. With this configuration, a backlight that uniformly emits white light is obtained.

### CITATION LIST

### Patent Literature

Patent Literature 1

Japanese Patent Application Publication, Tokukai, No. 2006-236951 A (Publication Date: Sep. 7, 2006)

Patent Literature 2

Japanese Patent Application Publication, Tokukai, No. 2003-187622 A (Publication Date: Jul. 4, 2003)

Patent Literature 3

Japanese Patent Application Publication, Tokukai, No. 2005-183124 A (Publication Date: Jul. 7, 2005)

Patent Literature 4

Japanese Patent Application Publication, Tokukai, No. 2005-332681 A (Publication Date: Dec. 2, 2005)

Patent Literature 5

Japanese Patent Application Publication, Tokukai, No. 2005-332680 A (Publication Date: Dec. 2, 2005)

### SUMMARY OF INVENTION

Like the above-described illumination device including combinations of red, green, and blue monochromatic light-emitting diodes, an illumination device using a plurality of light sources that emit light beams of different colors obtains white light by mixing the colored light beams. However, such an illumination device has the following problem. On an edge surface of the light guide, light emitted by a light-emitting diode disposed at the furthest edge accounts for a large proportion of the entire light. Therefore, for example, if the color of light emitted by the light-emitting diode disposed at the furthest edge is red, light emitted through a discontinuous side edge surface of the light guide is not quite white, rather a little reddish.

Speaking of an angular property of luminance of light emitted from a light-emitting diode, light of uniform luminance is not emitted from any angles. The luminance of light emitted frontward is highest, and the luminance decreases with increase of an angle from the front. For example, with use of light-emitting diodes of primary colors, R, G, and B, in order to obtain a white light source that achieves sufficient mixture of colored light beams when viewed from the front of the light-emitting diode R, it is necessary that light beams obliquely emitted from the light sources G and B disposed on the right side of the light source R and light beams obliquely emitted from the light sources G and B disposed on the left side of the light source R are guided to a part of a light-emitting section in front of the light source R, so that light beams of R, G, and B are mixed uniformly.

However, for example, at a right side edge surface of the light guide, although colored light beams emitted obliquely to the right from the light sources on the left side are mixed, the amounts of colored lights other than the colored light from the rightmost light-emitting diode decrease because there are no light sources on the right side of the rightmost light-emitting diode. Further, a light beam emitted from the light-emitting diode disposed at the rightmost edge to the right is totally reflected from the right edge of the end surface. This increases the amount of colored light from the rightmost light-emitting diode. As a result, light emitted through side edges of the end surfaces of the light guide are colored with the colors of the light beams from the light-emitting diodes disposed at the furthest edges. This has been the problem with the above configuration.

The present invention has been attained in view of the above problems, and an object of the present invention is to realize: an illumination device capable of providing white light generated by sufficient mixture of colored light beams, without coloration attributed to colors of light beams from light sources; and a liquid crystal display device including the illumination device.

In order to solve the above problems, an illumination device according to the present invention includes: a plurality of light sources which emit light beams of two or more different colors; and a plurality of light guides each of which mixes colored light beams emitted from the light sources and then converts the colored light beams thus mixed into surface emission, wherein the plurality of light guides are arranged so as not to overlap one another, the plurality of light sources are aligned in a given order along first end parts of each of the light guides, and scattering means for scattering light beams is provided on side surfaces of second end parts of each of the light guides, the second end parts facing a direction where the light sources are aligned.

An illumination device of the present invention is the so-called tile-type illumination device including a plurality of light sources and a plurality of light guides arranged so as not to overlap one another.

According to the above configuration, the scattering means is provided on the side surfaces of the second end parts of each of the light guides, the second end parts facing a direction where the light sources are aligned. This causes light incident upon the light guide from the light sources to be scattered without being totally reflected by the side surfaces of the second end parts of the light guide. As a result, the amount of light emitted from the light sources disposed at the first end parts decreases. This makes it possible to reduce coloration attributed to colors of light beams from the light sources disposed at the furthest edges of an array of light sources, and to thereby obtain uniformly-white light source.

An illumination device of the present invention may be configured such that the plurality of light sources are aligned along the first end parts that are two opposite end parts of each of the light guides, and the light sources aligned along one of the two opposite end parts emit light beams toward the light sources aligned along the other of the two opposite end parts.

According to the above configuration, irradiation of light can be performed in such a complementary manner that light from the light sources aligned along one of the two opposite end parts of the light guide reaches the areas which are inaccessible to light from the light sources aligned along the other end part. This allows for irradiation of uniform light from the entire light-emitting surface of the light guide.

In the above configuration, second end parts where the scattering means is provided, i.e. “second end parts of each of the light guides, the second end parts facing a direction where the light sources are aligned” can be rephrased as “second end parts of each of the light guides where the plurality of light sources are not aligned”.

An illumination device of the present invention may be configured such that the scattering means is scatterers respectively adhered to the side surfaces of the light guide.

According to the above configuration, the scatterers are adhered to the side surfaces of the light guide. This causes light incident upon the light guide from the light sources to be scattered without being totally reflected by the side surfaces of the second end parts of the light guide. As a result, it is possible to reduce coloration attributed to colors of light beams from the light sources disposed at the furthest edges, and to thereby obtain uniformly-white light source.

An illumination device of the present invention may be configured such that the scattering means is microfabrication provided on the side surfaces of the light guide.

According to the above configuration, the side surfaces of the light guide are subjected to microfabrication. This causes light incident upon the light guide from the light sources to be scattered without being totally reflected by the side surfaces of the second end parts of the light guide. As a result, it is possible to reduce coloration attributed to colors of light beams from the light sources disposed at the furthest edges, and to thereby obtain uniformly-white light source.

An illumination device of the present invention may be configured such that each of the light sources is a red light-emitting diode, a green light-emitting diode, or a blue light-emitting diode, and the light sources are constituted by a combination of the red, green, and blue light-emitting diodes.

According to the above configuration, it is possible to obtain an illumination device having light sources with a wide range of color reproduction.

In order to solve the above problems, an illumination device according to the present invention includes: a plurality of light sources which emit light beams of two or more different colors; and a plurality of light guides each of which mixes colored light beams emitted from the light sources and then converts the colored light beams thus mixed into surface emission, wherein the plurality of light guides are arranged so as not to overlap one another, each of the light guides has a plurality of concavities for arranging the plurality of light sources therein, the concavities being arranged along first end parts of each of the light guides, the plurality of light sources being placed in the concavities in a given order, and scattering means for scattering light beams is provided in light source alignment areas and their vicinities on at least one of front and back surfaces of the light guide.

An illumination device of the present invention is the so-called tile-type illumination device including a plurality of light sources and a plurality of light guides arranged so as not to overlap one another.

Here, the light source alignment areas and their vicinities are such a region that covers (i) the concavities where the light sources are aligned and (ii) their surroundings, and the region is one that can disturb total reflection conditions on the side surfaces of the opposite end parts of the light guide. That is, the region can be said as a region required to sufficiently mix colored light beams emitted from the light sources.

Further, “the front surface of the light guide” means a light-emitting surface of the light guide, and “the back surface of the light guide” means a surface opposite to the light-emitting surface.

According to the above configuration, the scattering means is provided in the light source alignment areas and their vicinities on at least one of the front and back surfaces of the light guide. This causes light incident upon the light guide from the light sources to be scattered around the light source alignment areas. As a result, the amount of light emitted from the light sources disposed particularly at the first end parts of the light guide decreases. This makes it possible to reduce coloration attributed to colors of light beams from the light sources disposed at the furthest edges of an array of the light sources, and to thereby obtain uniformly-white light source.

An illumination device of the present invention may be configured such that the plurality of light sources are aligned along the first end parts that are two opposite end parts of each of the light guides, and the light sources aligned along one of the two opposite end parts emit light beams toward the light sources aligned along the other of the two opposite end parts.

According to the above configuration, irradiation of light can be performed in such a complementary manner that light from the light sources aligned along one of the two opposite end parts of the light guide reaches the areas which are inaccessible to light from the light sources aligned along the other end part. This allows for irradiation of uniform light from the entire light-emitting surface of the light guide.

An illumination device of the present invention may be configured such that the scattering means is scatterers adhered to at least one of the front and back surfaces of the light guide.

According to the above configuration, the scattering means is provided in the light source alignment areas and their vicinities on at least one of the front and back surfaces of the light guide. This causes light incident upon the light guide from the light sources to be scattered around the light source alignment areas. As a result, the amount of light emitted from the light sources disposed particularly at the first end parts of the light guide decreases. This makes it possible to reduce coloration attributed to colors of light beams from the light sources disposed at the furthest edges of an array of the light sources, and to thereby obtain uniformly-white light source.

An illumination device of the present invention may be configured such that the scattering means is microfabrication provided on at least one of the front and back surfaces of the light guide.

According to the above configuration, the microfabrication is provided in the light source alignment areas and their vicinities on at least one of the front and back surfaces of the light guide. This causes light incident upon the light guide from the light sources to be scattered around the light source alignment areas. As a result, the amount of light emitted from the light sources disposed particularly at the first end parts of the light guide decreases. This makes it possible to reduce coloration attributed to colors of light beams from the light sources disposed at the furthest edges of an array of the light sources, and to thereby obtain uniformly-white light source.

An illumination device of the present invention may be configured such that each of the light sources is a red light-emitting diode, a green light-emitting diode, or a blue light-emitting diode, and the light sources are constituted by a combination of the red, green, and blue light-emitting diodes.

According to the above configuration, it is possible to obtain an illumination device having light sources with a wide range of color reproduction.

In order to solve the above problems, an illumination device according to the present invention includes: a plurality of light sources which emit light beams of two or more different colors; and a plurality of light guides each of which mixes colored light beams emitted from the light sources and then converts the colored light beams thus mixed into surface emission, wherein the plurality of light guides are arranged so as not to overlap one another, the plurality of light sources are aligned in a given order along first end parts of each of the light guides, and side surfaces of second end parts of each of the light guide serve as absorption surfaces for absorbing light beams, the second end parts facing a direction along an array of the light sources.

An illumination device of the present invention is the so-called tile-type illumination device including a plurality of light sources and a plurality of light guides arranged so as not to overlap one another.

According to the above configuration, the side surfaces of the second end parts of each of the light guide serve as light absorption surfaces, wherein the second end parts face a direction along the array of the light sources. This causes light incident upon the light guide from the light sources to be scattered without being totally reflected by the side surfaces of the second end parts of the light guide. As a result, the amount of light emitted from the light sources disposed at the first end parts decreases. This makes it possible to reduce coloration attributed to colors of light beams from the light sources disposed at the furthest edges of an array of light sources, and to thereby obtain uniformly-white light source.

An illumination device of the present invention may be configured such that the plurality of light sources are aligned along the first end parts that are two opposite end parts of each of the light guides, and the light sources aligned along one of the two opposite end parts emit light beams toward the light sources aligned along the other of the two opposite end parts.

According to the above configuration, irradiation of light can be performed in such a complementary manner that light from the light sources aligned along one of the two opposite end parts of the light guide reaches the areas which are inaccessible to light from the light sources aligned along the other end part. This allows for irradiation of uniform light from the entire light-emitting surface of the light guide.

In the above configuration, second end parts where the scattering means is provided, i.e. “second end parts of each of the light guides, the second end parts facing a direction where the light sources are aligned” can be rephrased as “second end parts of each of the light guides where the plurality of light sources are not aligned”.

An illumination device of the present invention may be configured such that each of the light sources is a red light-emitting diode, a green light-emitting diode, or a blue light-emitting diode, and the light sources are constituted by a combination of the red, green, and blue light-emitting diodes.

According to the above configuration, it is possible to obtain an illumination device having light sources with a wide range of color reproduction.

A liquid crystal display device according to the present invention includes: a liquid crystal display panel; and a backlight for emitting light beams to the liquid crystal display panel, wherein the backlight is any one of the above-described illumination devices.

A liquid crystal display device of the present invention includes an illumination device of the present invention as a backlight. With this configuration, it is possible to irradiate a liquid crystal panel with white light generated by sufficient mixture of colored light beams, and thus to improve display quality.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1

(a) of FIG. 1 is a cross-sectional view showing the configuration of a liquid crystal display device according to one embodiment of the present invention, and (b) of FIG. 1 is a plan view schematically showing a planar configuration of a light source unit provided in the liquid crystal display device according to one embodiment of the present invention.

FIG. 2

FIG. 2 is a plan view schematically showing the configuration of a backlight provided in the liquid crystal display device shown in (a) of FIG. 1.

FIG. 3

FIG. 3 is a plan view schematically showing the configuration of a light guide unit included in the backlight shown in FIG. 2.

FIG. 4

FIG. 4 is a graph showing chromaticity “x” of a light guide in a case where scatterers are provided on the side surfaces of the light guide and in a case where the scatterers are not provided thereon. The case where the scatterers are provided is indicated by an alternate long and short dashed line, and the case where the scatterers are not provided is indicated by a solid line.

FIG. 5

FIG. 5 is a graph showing chromaticity “y” of a light guide in a case where scatterers are provided on the side surfaces of the light guide and in a case where the scatterers are not provided thereon. The case where the scatterers are provided is indicated by an alternate long and short dashed line, and the case where the scatterers are not provided is indicated by a solid line.

FIG. 6

FIG. 6 is a plan view showing another example of the configuration of a light guide unit included in the backlight shown in FIG. 2.

FIG. 7

FIG. 7 is a plan view showing the configuration where absorbers are provided on side surfaces of the light guide unit included in the backlight shown in FIG. 2.

FIG. 8

FIG. 8 is a diagram showing an example of varied amounts of light beams emitted from a plurality of light sources aligned in a line in the light guide unit shown in FIG. 3.

FIG. 9

(a) of FIG. 9 is a cross-sectional view showing the configuration of a liquid crystal display device according to Second Embodiment of the present invention, and (b) of FIG. 9 is a plan view schematically showing a planar configuration of a light source unit provided in the liquid crystal display device according to Second Embodiment of the present invention.

FIG. 10

FIG. 10 is a plan view schematically showing the configuration of a backlight provided in the liquid crystal display device shown in (a) of FIG. 9.

FIG. 11

FIG. 11 is a plan view schematically showing the configuration of a light guide unit included in the backlight shown in FIG. 10.

FIG. 12

FIG. 12 is a view showing a modification example of the liquid crystal display device shown in FIG. 9, wherein (a) is a cross-sectional view showing the configuration of the liquid crystal display device according to the modification example, and (b) is a plan view schematically showing a planar configuration of a light source unit provided in the liquid crystal display device according to the modification example.

### DESCRIPTION OF EMBODIMENTS

### First Embodiment

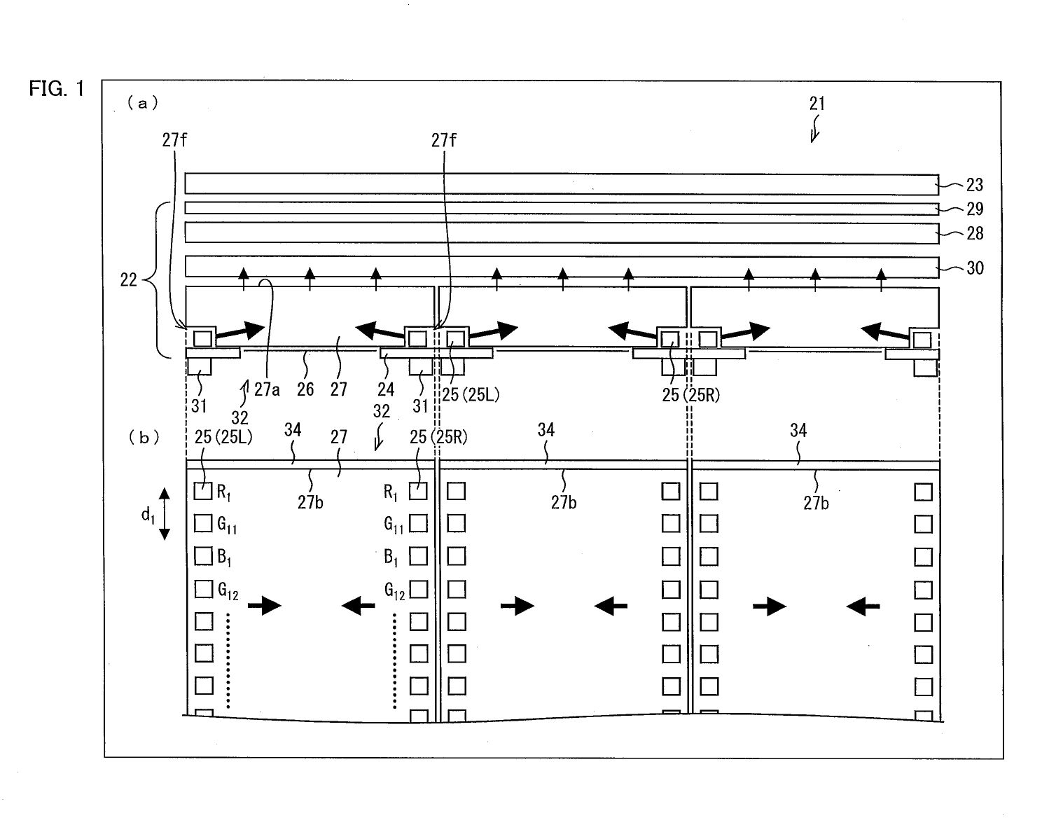

The following will describe one embodiment of the present invention with reference to FIGS. 1 through 8. Note that the following description is not intended to limit the scope of the present invention.

In the present embodiment, a tile-type backlight having a plurality of light guides are arranged all in the same plane so as not to overlap one another will be described.

FIG. 1 schematically shows the configuration of a liquid crystal display device 21 according to the present embodiment. (a) of FIG. 1 is a cross-sectional view of the liquid crystal display device 21, and (b) of FIG. 1 is a plan view schematically showing a planar configuration of the light source unit 32 provided in the liquid crystal display device 21. The liquid crystal display device 21 includes a backlight 22 (illumination device) and a liquid crystal display panel 23 that is opposed to the backlight 22.

The liquid crystal display panel 23 has a configuration similar to that of a general liquid crystal display panel for use in the conventional liquid crystal display device. The liquid crystal display panel 23, for example, includes (although not shown): an active matrix substrate with a plurality of TFTs (thin-film transistors) provided thereon; a color filter (CF) substrate that is opposed to the active matrix substrate, and a liquid crystal layer between the two substrates which is sealed with a sealing material.

Next, the following will describe the configuration of the backlight 22 included in the liquid crystal display device 21.

The backlight 22 is provided behind the liquid crystal display panel 23 (on a surface side which is opposite to a display surface). As shown in (a) of FIG. 1, the backlight 22 includes substrates 24, light sources 25, reflecting sheets 26, light guides 27, a diffusing plate 28, an optical sheet 29, a transparent plate 30, drivers 31, and scatterers 34 (scattering means).

Each of the light sources 25 is, for example, a dotted light source such as a side light-emitting type light-emitting diode (LED). The following description will take LEDs as an example of the light sources 25. In the present embodiment, used as the light sources 25 are the following side light-emitting type LEDs that respectively emit light beams of three different colors: a red light-emitting diode that emits light of red (R), a green light-emitting diode that emits light of green (G), and a blue light-emitting diode that emits light of blue (B). With this configuration, it is possible to obtain an illumination device with a wide range of color reproduction. Note that the light sources 25 are placed on the substrates 24. However, the present invention is not limited to such a configuration. The light sources 25 may be anything as long as they are a plurality of light sources that emit light beams of two or more different colors.

Each of the light guides 27 converts light beams emitted from the light sources 25 to surface emission from a light-emitting surface 27a. The light-emitting surface 27a is a surface for irradiating a target with light. Since a backlight of the present invention has a plurality of light sources that emit light beams of two or more different colors, a light guide has a capability of mixing the light beams of different colors from the light sources and converting the colored light beams thus mixed to surface emission.

Further, the light guide 27 is formed from a transparent resin such as polycarbonate (PC) or polymethylmethacrylate (PMMA). However, this is not the only possibility. The light guide 27 is preferably formed from a material with high transmittance. Still further, the light guide 27 can be formed by a method such as injection molding, extrusion molding, press molding with heat, or cutting, for example. However, the present embodiment is not limited to the methods. Any processing method can be employed as long as it brings about properties similar to those of any of the methods.

Each of the reflecting sheets 26 is provided so as to be in contact with a back surface of the light guide (a surface opposite to the light-emitting surface 27a). The reflecting sheet 26 reflects light so that the light-emitting surface 27a emit more amount of light. The backlight 22 of the present embodiment includes a plurality of light guides 27, and each of the reflecting sheets 26 is provided for each of the light guides 27.

The diffusing plate 28 is opposed to the light-emitting surfaces 27a so as to cover the entire area of the light-emitting surfaces 27a of the light guides 27 which surfaces are flush with each other. The diffusing plate 28 diffuses light beams emitted from the light-emitting surfaces 27a of the light guides 27 and then irradiates the later-described optical sheet with the diffused light beams. In the present embodiment, a 2.0 mm-thick “SUMIPEX E RMA10” manufactured by Sumitomo Chemical Co., Ltd is used as the diffusing plate 28. The diffusing plate 28 may be placed at a predetermined distance from the light-emitting surfaces 27a. The predetermined distance is set to 3.0 mm, for example.

The optical sheet 29 is placed in the front of the light guides 27 and is made up of a plurality of sheets stacked on top of each other. The optical sheet 29 uniforms and converges light emitted from the light-emitting surface 27a of the light guide 27 and then irradiates the liquid crystal display panel 23 with the uniformed and converged light. That is, the optical sheet 29 can be realized by sheets such as (i) a diffusing sheet for simultaneously converging and diffusing incident light, (ii) a lens sheet for converging incident light so as to improve luminance obtained when viewed from a front direction (i.e., a direction pointing to the liquid crystal display panel), and (iii) a polarizing and reflecting sheet for reflecting one polarized component of light and transmitting the other polarized component so as to improve luminance of the liquid crystal display device 21.

It is preferable that these sheets are appropriately combined with each other in consideration of an intended price and/or performance of the liquid crystal display device 21. In the present embodiment, as an example, “LIGHT-UP 250GM2” manufactured by Kimoto Co., Ltd. is used as the diffusing sheet, “Thick RBEF” manufactured by Sumitomo 3M Ltd. is used as a prism sheet, and “DBEF-D400” manufactured by Sumitomo 3M Ltd. is used as a polarizing sheet.

The transparent plate 30 is used for the purpose of keeping a distance between the light guide 27 and the diffusing plate 28 at a given distance, and forms a light-diffusing region. The transparent plate 30 is formed from a transparent material such as a polyethylene film. Optionally, the transparent plate 30 may be omitted so that the light guide 27 and the diffusing plate 28 are opposed to each other.

The drivers 31 each perform lighting control of the light sources 25. Further, the driver 31 is capable of adjusting luminous intensity of light emitted from the light sources 25. The driver 31 is placed on the undersurface of the substrate 24 (on the side opposite to the side where the light source 25 is provided). The drivers 31 perform lighting control by supplying electric currents, etc. to the light sources 25. Therefore, the driver 31 can be also termed a light source control section.

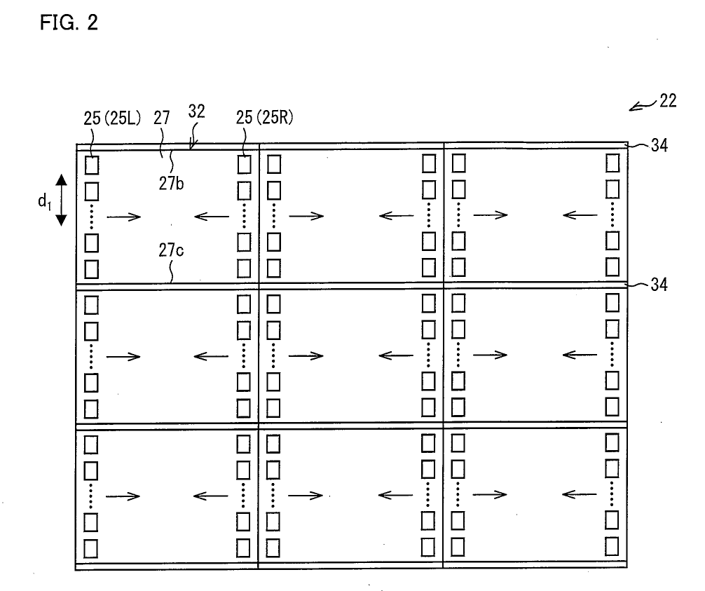

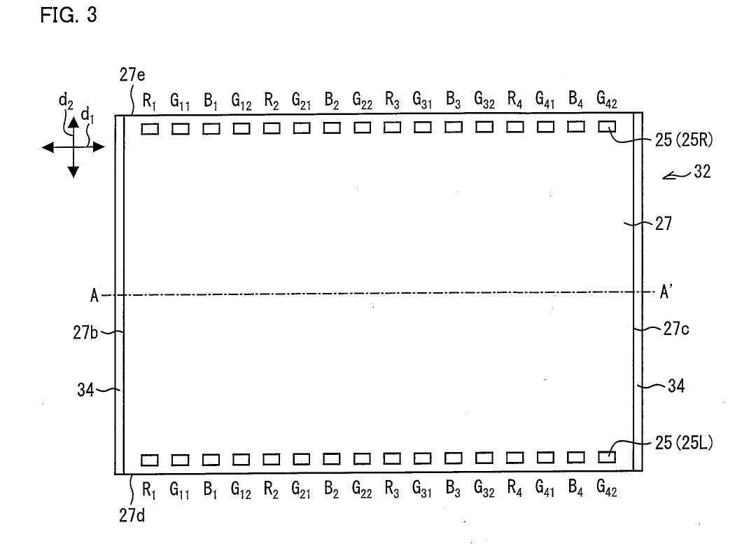

The scatterers 34 are members for scattering light, and are provided at opposite end parts 27b and 27c of each of the light guides 27, which opposite end parts 27b and 27c face the direction d1 where the light sources 25 are aligned (see FIGS. 2 and 3).

In the present embodiment, the backlight 22 includes a plurality of light guides. As shown in (a) and (b) of FIG. 1, the backlight 22 is configured such that a plurality of light source units 32 are arranged all in the same plane so as not to overlap one another. Each of the light source units 32 is a combination of one light guide 27 and a plurality of light sources 25.

FIG. 2 schematically shows a planar configuration of the backlight 22. As shown in FIG. 2, the backlight 22 is configured such that the plurality of light source units 32 are arranged lengthwise and crosswise. In this manner, the backlight 22 of the present embodiment is such that the plurality of light source units 32 are arranged as if tiles are spread over the backlight 22. Therefore, the backlight 22 of the present embodiment is termed a tile-type backlight.

With use of such a tile-type backlight, it is possible to realize a sufficient luminance and an excellent luminance uniformity even in a case where the tile-type backlight is employed in a large liquid crystal display device. Further, with such a configuration that the light guides are arranged so as not to overlap one another, it is possible to realize reduction in thickness of the device.

FIG. 3 shows the configuration of one of the light source units 32 included in the backlight 22. FIG. 3 is a plan view (top view) of the light source unit 32 when the plurality of light source units 32 arranged in a tiled manner are viewed from the liquid crystal display panel 23 side (which is assumed to be a top surface side).

As shown in FIG. 3, one light source unit 32 includes: one light guide 27 for converting light from the light sources to surface emission; and a plurality of light sources 25 arranged in a given order along two opposite end parts 27d and 27e of the light guide 27. As indicated in the light guide 27 of FIG. 3, a direction where the light sources are aligned is referred to as a width direction d1 of the light guide, and a direction substantially orthogonal to the width direction d1 is referred to as a length direction d2 of the light guide.

In (a) and (b) of FIG. 1, the light sources 25 aligned in a row along a left-hand end part of the two opposite end parts of the light guide 27 are given reference sign 25L, and the light sources 25 aligned in a row along a right-hand end part of the two opposite end parts of the light guide 27 are given reference sign 25R. Further, as shown in (a) of FIG. 1, the light sources 25 (25L and 25R) are placed in hollow-like concavities 27f that are provided inside the light guide 27.

The light sources 25L and 25R are placed on the substrate 24. As shown in (a) and (b) of FIG. 1, a direction (indicated by arrows) in which light is emitted from the light sources 25L and 25R is adjusted in such a manner that light from one array of light sources (e.g. the array of the light sources 25L) is directed toward the other array of light sources (e.g. the array of the light sources 25R). In other words, the light sources 25 emit light toward the midsection of the light guide 27 in the length direction d2.

As described above, in the light source unit 32, the light source arrays in two rows opposed to each other are arranged in such a manner that light from one of the light source arrays covers the area which is inaccessible to light from the other light source array. With this configuration, one of the light source arrays emits light so as to complement a dead area of the other of the light source arrays, so that light is emitted from the entire light-emitting surface. This makes it possible to improve luminance uniformity of light from the backlight 22.

In other words, the array of the light sources 25L and the array of the light sources 25R are opposed to each other so that light beams from both of the light source arrays are directed into the inside of the light guide 27. This makes it possible to cause light-emitting areas of the respective light sources to overlap, and thus to obtain emission of light from the entire light-emitting surface 27a of the light guide 27.

In the present embodiment, a plurality of light source units 32 with the above-described configuration are arranged. This makes it possible to obtain a large backlight that produces no dark areas. Further, as shown in (a) of FIG. 1, the backlight 22 of the present embodiment is configured such that the light source units 32 are arranged all in the same plane so as not to overlap one another. This results in a flush light-emitting surface (light-emitting surface of the whole backlight 22; light-emitting area) formed by the light-emitting surfaces 27a of the respective light guides 27.

With the above configuration, light emitted from the light sources 25 travels through the inside of the light guide 27 while being subjected to scattering action and reflecting action. Then, the light exits from the light-emitting surface 27a, passes through the diffusing plate 28 and the optical sheet 29, and finally reaches the liquid crystal display panel 23.

As described above, the plurality of light sources 25 are mounted on the substrate 24 and each aligned along one end part of the light guide 27. In the present embodiment, the LEDs of the following three colors: red (R), green (G), and blue (B) are used as the light sources 25. As shown in FIG. 3, the light sources are aligned along the end parts 27d and 27e of the light guide 27 in a direction pointing from a side surface of one end part 27b of the light guide 27 to a side surface of the other end part 27c that is opposite to the end part 27b, in the following order: R1, G11, B1, G12, R2, G21, B2, G22, . . . R4, G41, B4, and G42. The light sources are aligned with a sequence of R, G, B, and G as one group. As shown in FIG. 3, the light source unit 32 of the present embodiment is such that the plurality of light sources 25 are aligned in a given order along the two opposite end parts 27d and 27e of the light guide 27. In FIG. 3, the light sources aligned along the end part 27d each are given reference numeral 25L, and the light sources aligned along the end part 27e each are given reference numeral 25R.

In addition, in the present embodiment, as shown in FIGS. 2 and 3, the scatterer 34 (scattering means) is adhered to the side surface of the end part 27b of the light guide 27 which end part 27b faces in the width direction d1 (the direction where the light sources 25 are aligned).

As shown in FIGS. 1 through 3, the width direction d1 of the light guide 27 is a direction along the array of the light sources 25 aligned in a given order. Further, as shown in FIG. 3, the direction intersecting with the width direction d1 (specifically, the direction substantially orthogonal to the width direction d1) is the length direction d2 of the light guide 27. The length direction d2 of the light guide 27 is also referred to as a direction where light is emitted from the light-emitting diode 25 (direction where a main component of the light is emitted).

Specific examples of the scatterer include an adhesive and a white reflecting sheet. By using one of these, light incident upon the light guide 27 from the light-emitting diodes 25 (specifically, LED “R1” and LED “G42”) disposed at the positions closest to the opposite end parts 27b and 27c of the light guide 27 is scattered without being totally reflected by the side surfaces. This decreases the amounts of light from the LEDs “R1” and “Gn2” at the end parts 27b and 27c of the light guide. It is therefore possible to reduce red or green coloration in the light-emitting surface 27a, and thus to obtain a uniformly-white illumination device.

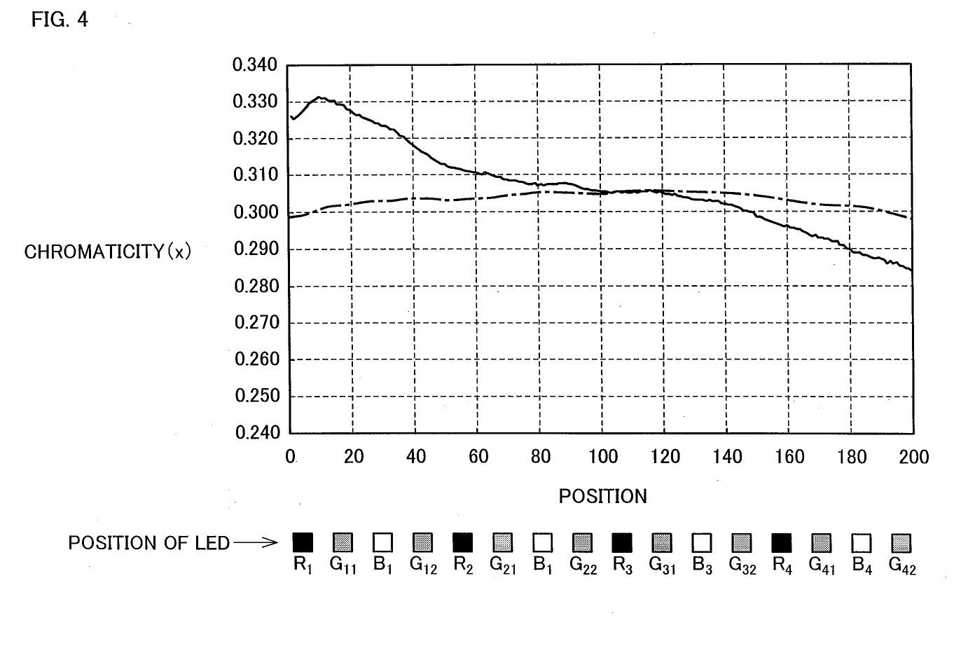

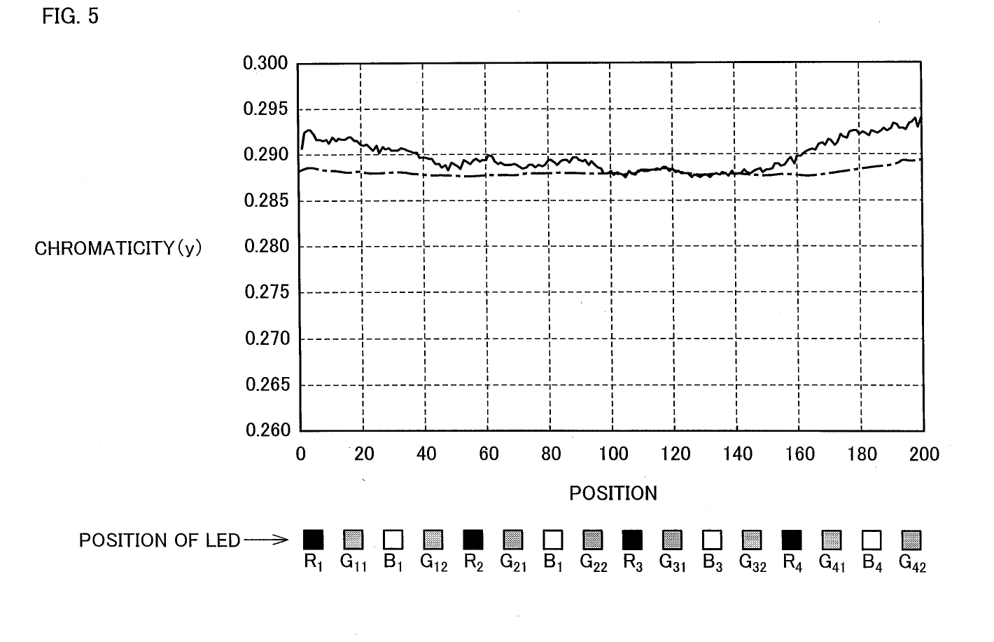

FIG. 4 is a graph showing chromaticity “x” of a section A-A′ shown in FIG. 3 in a case where the scatterers 34 are provided on the side surfaces of the light guide 27 and in a case where the scatterers 34 are not provided. FIG. 5 is a graph showing chromaticity “y” of the section A-A′ shown in FIG. 3 in a case where the scatterers 34 are provided on the side surfaces of the light guide 27 and in a case where the scatterers 34 are not provided. In FIGS. 4 and 5, a lateral axis indicates positions on the end part 27d of the light guide. The lateral axis is divided by tick marks that represent the positions of the LEDs in the following manner. That is, the position closest to the end part 27b is “0”, the position in the midsection is “100”, and the position closest to the end part 27c is “200”. In FIGS. 4 and 5, the case where the scatterers are provided is indicated by alternate long and short dashed lines, and the case where the scatterers are not provided is indicated by solid lines.

In the case where the scatterer is not provided, results are as indicated by the solid lines in FIGS. 4 and 5. That is, there is little difference in chromaticity “y” between the side edge surfaces of the opposite end parts 27b and 27c of the light guide, while a value of chromaticity “x” at the position on the end part 27b side of the light guide is comparatively higher than that of chromaticity “x” at the position on the end part 27c side of the light guide. On this account, red coloration occurs at the position on the end part 27b side of the light guide. However, in the case where the scatterers are provided on the side surfaces of the light guide as in the present embodiment, results are as indicated by the alternate long and short dashed lines in FIGS. 4 and 5. That is, both chromaticity “x” and chromaticity “y” remain constant at any positions on the light guide.

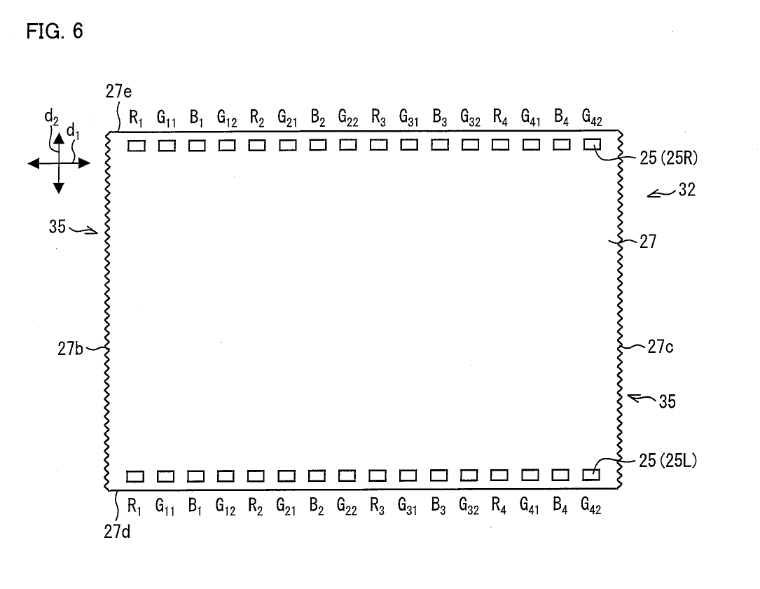

Further, the same effect as the above effect can be obtained by disturbing total reflection conditions of the side surfaces of the end parts 27b and 27c through a method of subjecting the end parts 27b and 27c to microfabrication, as well as the method of adhering the scatterers to the end parts 27b and 27c. More specifically, as shown in FIG. 6, the scattering means are realized by subjecting the side surfaces of the opposite end parts 27b and 27c which face in the width direction d1 of the light guide 27 to microfabrication 35. The microfabrication is obtained by filing the side surfaces of the opposite end parts 27b and 27c. Alternatively, the microfabrication is obtained by roughing the surface of the light guide by sandblasting or the like method. Further alternatively, the microfabrication is obtained by processing the surfaces of the light guide so that it works as a prism and a lens.

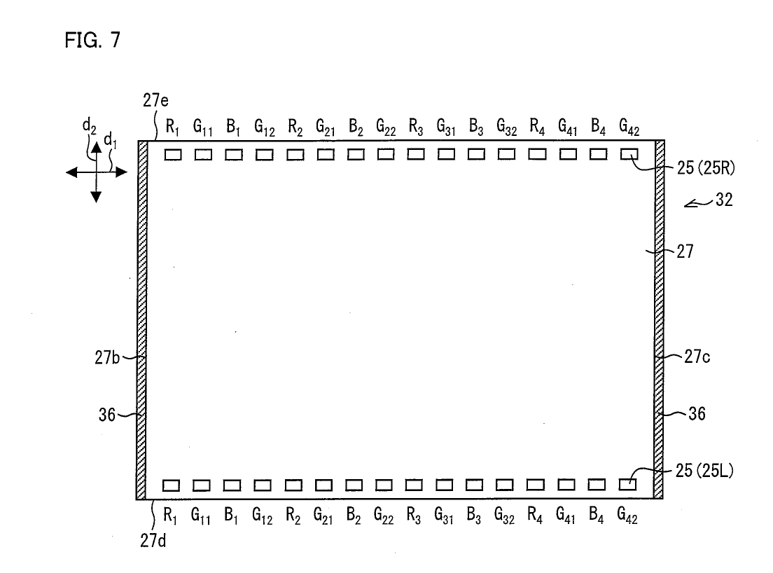

Still further, the same effect as the above effect can be obtained by disturbing total reflection conditions of the side surfaces of the opposite end parts 27b and 27c through a method of forming absorption surfaces at the opposite end parts 27b and 27c of the light guide 27 which face in the width direction d1, as well as the above-described methods for providing the scattering means. The absorption surfaces are obtained by printing black on the side surfaces of the end parts 27b and 27c. As shown in FIG. 7, the absorption surfaces can also be obtained by adhering absorbers 36 (e.g. black-colored paper) having a property of absorbing light to the side surfaces of the end parts 27b and 27c.

Luminous intensities of the light sources aligned in a given order along the end part 27d of the light guide 27 may be all equal to or different from one another.

The following will describe a case where the luminous intensities of the light sources are different from one another.

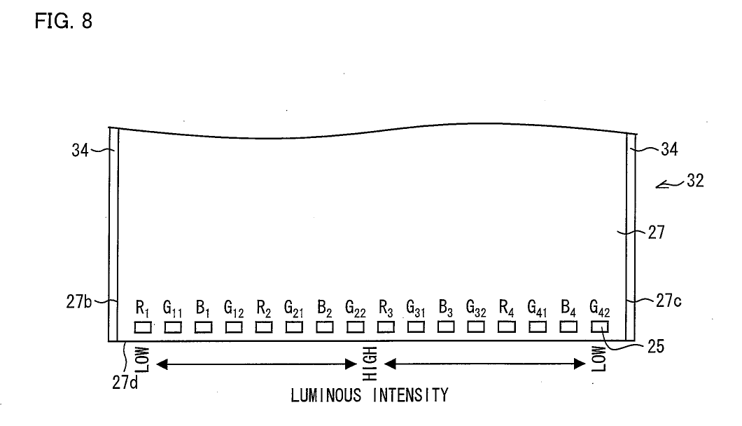

FIG. 8 shows a relation between the luminous intensities of the light sources aligned in a given order along one end part 27d of the light guide 27. As shown in FIG. 8, the light source unit 32 is arranged such that the light sources (e.g. G22 and R3) positioned in the midsection of one end part of the light guide have the highest luminous intensity among the plurality of light sources aligned in a line along the light guide, and luminous intensities of the other light sources decrease with distance from the light sources having the highest luminous intensity. Conversely, the light sources 25 (e.g. R1 and G42) arranged at the positions closest to the end parts 27b and 27c of the light guide have the lowest luminous intensity, and luminous intensities of the other light sources increase with distance toward the light sources positioned near the midsection of each end part of the light guide. As in the above case, at the other end part 27e opposite to the end part 27d, the light sources 25R positioned in the midsection of the end part 27e have the highest luminous intensity among the light sources 25R aligned in a line, and luminous intensities of the other light sources 25R decrease with distance from the light sources having the highest luminous intensity (not shown).

With the above-described setting of the luminous intensities of the light sources 25, it is possible to prevent, in the discontinuous side edge surfaces (i.e. the side surfaces of the end parts 27b and 27c) of the light guide 27, the occurrence of coloration attributed to the color of light from the light sources disposed in the positions close to the side edge surfaces. In addition, it is possible to reduce coloration in areas positioned slightly inside the side edge surfaces of the light guide. Thus, it is possible to sufficiently mix colored light beams together in the entire area of the light guide. This makes it possible to obtain the backlight 22 that emits white light without coloration.

The color combination of the LEDs and the color sequence of the LEDs are not limited to the above examples. Further, the light sources are preferably spaced at a given interval, but do not need to be so disposed.

Instead of being arranged with a color sequence of “R, G, B, and G” as one group, the LEDs may be arranged, for example, with a sequence of “G, R, B, and G” as one group as described in Patent Literature 5, paragraph [0089]. Such an arrangement of the LEDs R, G, and B makes it possible to further improve color mixture.

In the above-described example, in the light source array in which the light sources are aligned in a line along the end parts 27d and 27e, the light source 25 positioned at the midsection of the end part has the highest luminous intensity, and luminous intensities of the other light sources 25 decrease with distance from the light source positioned at the midsection of the end part (i.e. with increasing proximity to the end parts 27b and 27c of the light guide 27).

In this case, adjustment of luminous intensities of the light sources 25 can be achieved by a method of controlling values of electric current to be supplied from the driver 31 to the LEDs. Examples of other method for adjusting the luminous intensities include a method of decreasing width of a pulse to be supplied from the driver 31 to each of the LEDs. In this manner, the driver 31 serves as luminous intensity adjusting means by performing drive control of the LEDs.

The above-described methods for adjusting luminous intensities of the light sources are just a few examples of the present invention. These are not intended to limit the scope of the present invention.

### Second Embodiment

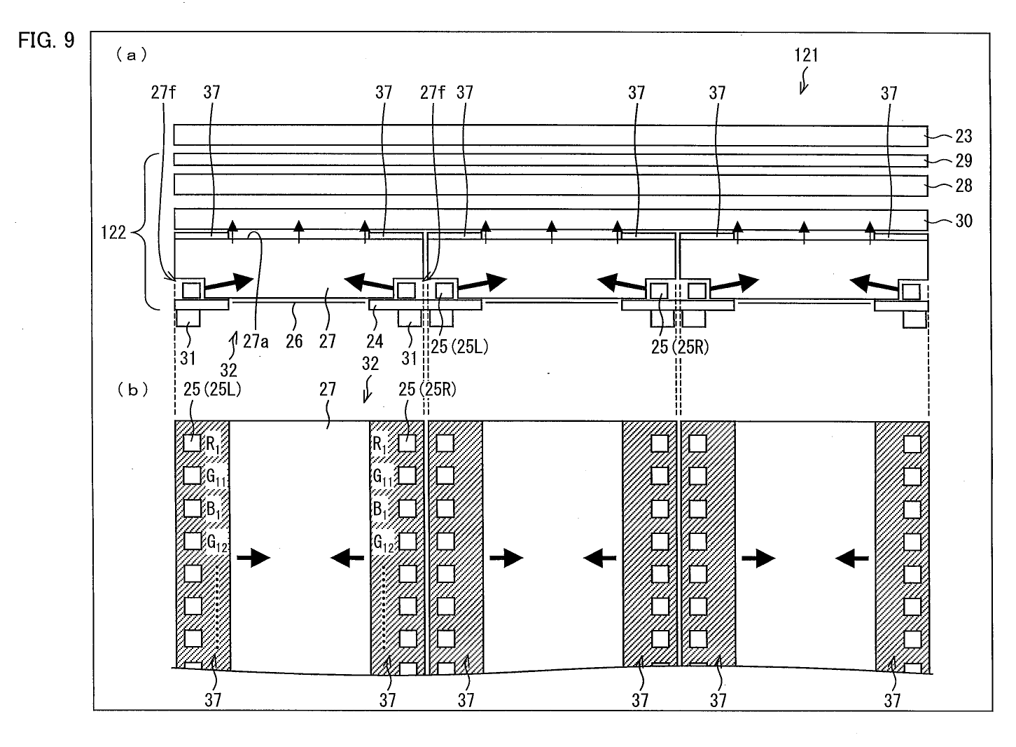

The following will describe Second Embodiment of the present invention with reference to FIGS. 9 through 12. First Embodiment has described the configuration in which the scatterers or the like are provided on the side surfaces of the end parts of the light guide which face in the width direction d1. However, the present embodiment will describe the configuration in which scatterers 37 or 38 (scattering means) are provided in light source alignment areas and their vicinities on the front or back surface of the light guide.

Also, in the present embodiment, as is the case with First Embodiment, a tile-type backlight configured such that a plurality of light guides are arranged all in the same plane so as not to overlap one another will be described.

FIG. 9 schematically shows the configuration of a liquid crystal display device 121 according to the present embodiment. (a) of FIG. 1 is a cross-sectional view of the liquid crystal display device 121, and (b) of FIG. 1 is a plan view schematically showing a planar configuration of a light source unit 32 provided in the liquid crystal display device 121. The liquid crystal display device 121 includes a backlight 122 (illumination device) and a liquid crystal display panel 23 that is opposed to the backlight 122.

The liquid crystal display panel 23 has a configuration similar to that of a general liquid crystal display panel for use in the conventional liquid crystal display device. The liquid crystal display panel 23, for example, includes (although not shown): an active matrix substrate with a plurality of TFTs (thin-film transistors) provided thereon; a color filter (CF) substrate that is opposed to the active matrix substrate, and a liquid crystal layer between the two substrates which is sealed with a sealing material.

Next, the following will describe the configuration of the backlight 122 included in the liquid crystal display device 121. Note that members of the backlight 122 which are identical to those of the backlight 22 described in First Embodiment are given the same reference numerals, and explanation thereof are omitted here.

The backlight 122 is provided behind the liquid crystal display panel 23 (on a surface side which is opposite to a display surface). As shown in (a) of FIG. 9, the backlight 122 includes substrates 24, light sources 25, reflecting sheets 26, light guides 27, a diffusing plate 28, an optical sheet 29, a transparent plate 30, drivers 31, and scatterers 37 (scattering means).

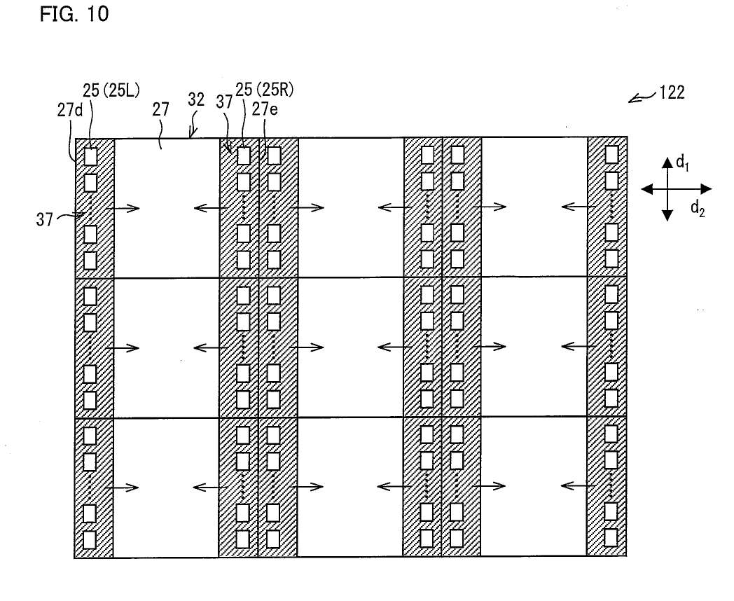

Among these members of the backlight 122, the scatterers 37 are different from the scatterers of the backlight 22 described in First Embodiment. The scatterers 37 scatter light. In the present embodiment, the scatterers 37 are provided in light source alignment areas and their vicinities on the front surface of the light guide 27 (i.e. light-emitting surface 27a) (see FIGS. 9 and 10). In (b) of FIG. 9 and FIG. 10, the areas where the scatterers 37 are provided are hatched.

In the present embodiment, the backlight 122 includes a plurality of light guides. As shown in (a) and (b) of FIG. 9, the backlight 122 is configured such that a plurality of light source units 32 are arranged all in the same plane so as not to overlap one another. Each of the light source units 32 is a combination of one light guide 27 and a plurality of light sources 25.

FIG. 10 schematically shows a planar configuration of the backlight 122. As shown in FIG. 10, the backlight 122 is configured such that the plurality of light source units 32 are arranged lengthwise and crosswise. In this manner, the backlight 122 of the present embodiment is such that the plurality of light source units 32 are arranged as if tiles are spread over the backlight 122. Therefore, the backlight 122 of the present embodiment is termed a tile-type backlight.

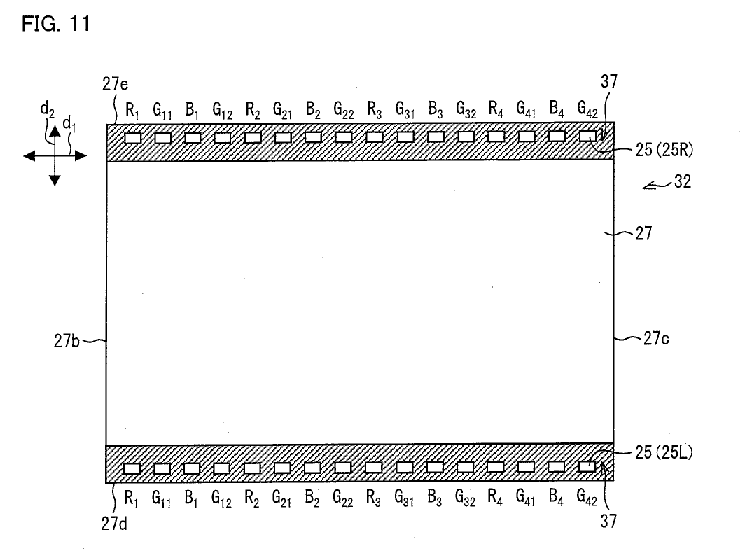

FIG. 11 shows the configuration of one of the light source units 32 included in the backlight 22. FIG. 11 is a plan view (top view) of the light source unit 32 when the plurality of light source units 32 arranged in a tiled manner are viewed from the liquid crystal display panel 23 side (which is assumed to be a top surface side).

As shown in FIG. 11, one light source unit 32 includes: one light guide 27 for converting light from the light sources to surface emission; and a plurality of light sources 25 arranged in a given order along two opposite end parts 27d and 27e of the light guide 27. As indicated in the light guide 27 of FIG. 3, a direction where the plurality of light sources are aligned is referred to as a width direction d1 of the light guide, and a direction substantially orthogonal to the width direction d1 is referred to as a length direction d2 of the light guide.

As in the case with the configuration described in First Embodiment, the plurality of light sources 25 are mounted on the substrate 24 and each aligned along one end part of the light guide 27. In the present embodiment, the LEDs of the following three colors: red (R), green (G), and blue (B) are used as the light sources 25. As shown in FIG. 11, the light sources are aligned along the end parts 27d and 27e of the light guide 27 in a direction pointing from a side surface of one end part 27b of the light guide 27 to a side surface of the other end part 27c that is opposite to the end part 27b, in the following order: R1, G11, B1, G12, R2, G21, B2, G22, . . . R4, G41, B4, and G42. The light sources are aligned with a sequence of R, G, B, and G as one group.

As shown in FIG. 11, the light source unit 32 of the present embodiment is such that the plurality of light sources 25 are aligned in a given order along the two opposite end parts 27d and 27e of the light guide 27. In FIG. 11, the light sources aligned along the end part 27d each are given reference numeral 25L, and the light sources aligned along the end part 27e each are given reference numeral 25R.

As shown in (a) of FIG. 9, the light sources 25 (25L and 25R) are placed in hollow-like concavities 27f that are provided inside the light guide 27. That is, the light guide 27 has a plurality of concavities 27f for arranging the light sources 25 (25L and 25R) in a given order therein respectively at the two opposite end parts 27e and 27d.

The scatterers 37 are adhered to the light source alignment areas (areas covering the light sources 25 when viewed from the light-emitting surface side) and their vicinities on the front surface of the light guide 27 (i.e. light-emitting surface 27a).

With this configuration, for example, light incident upon the light guide 27 from the LEDs “R1”, which lie at the positions closest to the end part 27b of the light guide 27, undergoes disturbance of total reflection conditions caused by the scatterers. This decreases the amount of light incident upon the end parts of the light guide from the LEDs “R1”.

Specific examples of the scatterer 37 include an adhesive and a white reflecting sheet. By using one of these, light incident upon the light guide 27 from the light-emitting diodes 25 (specifically, LED “R1” and LED “Gn2”) disposed at the positions closest to the opposite end parts 27b and 27c of the light guide 27 is scattered without being totally reflected by the side surfaces of the end parts 27b and 27c. This decreases the amounts of light from the LEDs “R1” and “Gn2” at the end parts of the light guide. It is therefore possible to reduce red or green coloration in the light-emitting surface 27a, and thus to obtain a uniformly-white illumination device.

The areas where the scatterers 37 are provided, i.e. “the light source alignment areas and their vicinities” are a region that covers (i) the concavities 27f in which the light sources 25 are aligned and (ii) their surroundings. The region is one that can disturb the total reflection conditions on the side surfaces of the opposite end parts 27b and 27c of the light guide 27. That is, the region can be said as a region required to sufficiently mix colored light beams emitted from the light sources.

In the above-described embodiment, the configuration where the scatterers 37 are provided only on the front surface of the light guide 27 is described. However, the present invention is not necessarily limited to such a configuration. In the present invention, the scatterers (scattering means) may be adhered to the front surface or the back surface of the light guide 27. Alternatively, the scatterers may be adhered to both of the front and back surfaces.

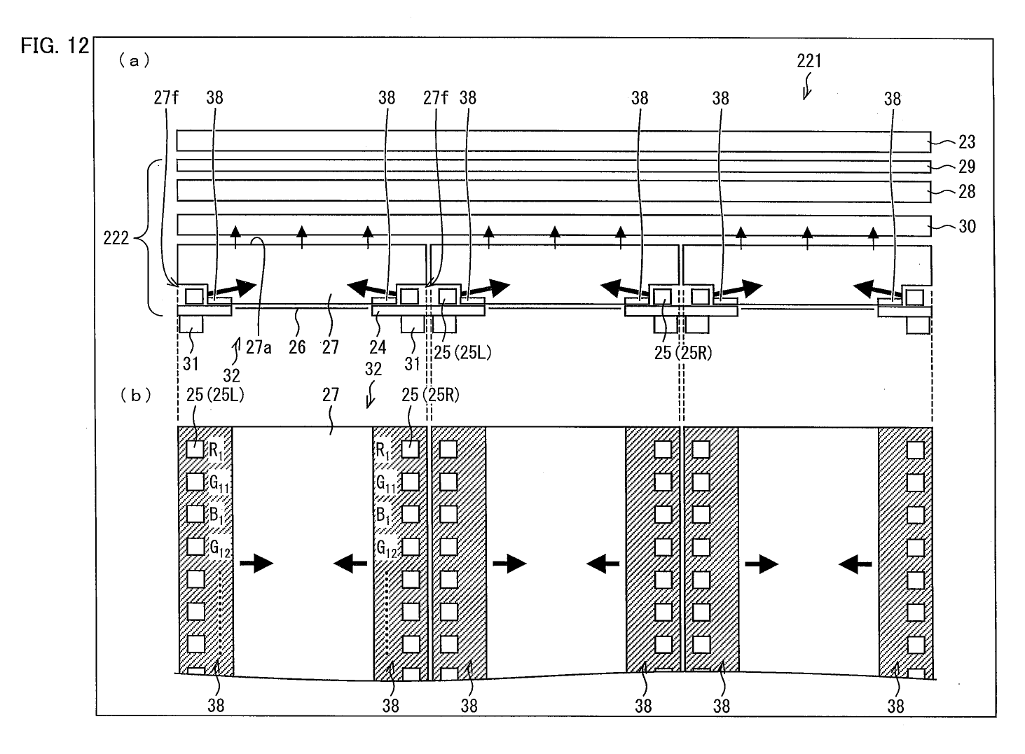

FIG. 12 shows, as a modification of the liquid crystal display device of the present embodiment, a configuration where the scatterers are provided on the back surface of the light guide. As shown in FIG. 12, a backlight 222 included in a liquid crystal display device 221 is configured such that scatterers 38 are provided in the light source alignment areas and their vicinities (i.e. surroundings of the concavities 27 in which the light sources 25 are aligned) on the back surface of the light guide 27 (surface opposite to the light-emitting surface 27a).

Further, in the present invention, the above-described effect can be obtained by disturbing total reflection conditions of the side surfaces of the end parts 27b and 27c through a method of subjecting the front and/or back surface of the light guide to microfabrication, as well as the method of adhering the scatterers to the light source alignment areas and their vicinities on at least one of the front and back surfaces of the light guide. In other words, it is possible to realize the scattering means by subjecting to microfabrication the neighborhood of the end parts of the light guide 27 which end parts face in the width direction d1, in the light source alignment areas and their vicinities on the front and/or back surface of the light guide 27. Note that the microfabrication may be performed on the front surface or the back surface, or may be performed on both of the front and back surfaces.

The microfabrication is obtained by filing the front or back surface of the predetermined areas of the light guide 27. Alternatively, the microfabrication is obtained by roughing the surface(s) of the light guide by sandblasting or the like method. Further alternatively, the microfabrication is obtained by processing the surface(s) of the light guide so that it works as a prism and a lens.

The present invention is not limited to the aforementioned embodiments and is susceptible of various changes within the scope of the accompanying claims. Also, an embodiment obtained by suitable combinations of technical means disclosed in the different embodiments are also included within the technical scope of the present invention.

An illumination device of the present invention is configured such that the plurality of light sources are aligned in a given order along first end parts of each of the light guides, and scattering means for scattering light beams is provided on side surfaces of second end parts of each of the light guides, the second end parts facing a direction where the light sources are aligned.

Further, an illumination device of the present invention is configured such that each of the light guides has a plurality of concavities for arranging the plurality of light sources therein, the concavities being arranged along first end parts of each of the light guides, the plurality of light sources being placed in the concavities in a given order, and scattering means for scattering light beams is provided in light source alignment areas and their vicinities on at least one of front and back surfaces of the light guide.

Still further, an illumination device of the present invention is configured such that the plurality of light sources are aligned in a given order along first end parts of each of the light guides, and side surfaces of second end parts of each of the light guide serve as absorption surfaces for absorbing light beams, the second end parts facing a direction along an array of the light sources.

Further, a liquid crystal display device according to the present invention has any of the illumination devices of the present invention as a backlight.

According to the present invention, it is therefore possible to realize: an illumination device capable of providing white light generated by sufficient mixture of colored light beams, without coloration attributed to colors of light beams from light sources; and a liquid crystal display device including the illumination device.

Specific embodiments or examples implemented in the description of the embodiments only show technical features of the present invention and are not intended to limit the scope of the invention. Variations can be effected within the spirit of the present invention and the scope of the following claims.

### INDUSTRIAL APPLICABILITY

An illumination device of the present invention, which is capable of providing white light generated by sufficient mixture of colored light beams, is suitably used as a backlight for use in a liquid crystal display device. An illumination device of the present invention realizes improvement of display quality of a liquid crystal display device.

### REFERENCE SIGNS LIST

21 liquid crystal display device
22 backlight (illumination device)
23 liquid crystal display panel
25 (25L, 25R) light source (LED)
27 light guide
27a light-emitting surface
27b, 27c end parts (in the width direction of the light guide)
27d, 27e end parts (in the length direction of the light guide)
31 driver
34 scatterer (scattering means) (provided on the side surfaces of the light guide)
35 microfabrication (scattering means) provided on the side surfaces of the light guide)
36 absorber (absorption surface)
37 scatterer (scattering means) (provided on the front surface of the light guide)
38 microfabrication (scattering means) (provided on the back surface of the light guide)
121 liquid crystal display device
122 backlight (illumination device)
221 liquid crystal display device
222 backlight (illumination device)

1. An illumination device comprising:
a plurality of light sources which emit light beams of two or more different colors; and
a plurality of light guides each of which mixes colored light beams emitted from the light sources and then converts the colored light beams thus mixed into surface emission, wherein
the plurality of light guides are arranged so as not to overlap one another,
the plurality of light sources are aligned in a given order along first end parts of each of the light guides, and
scattering means for scattering light beams is provided on side surfaces of second end parts of each of the light guides, the second end parts facing a direction where the light sources are aligned.

2. The illumination device according to claim 1, wherein
the plurality of light sources are aligned along the first end parts that are two opposite end parts of each of the light guides, and
the light sources aligned along one of the two opposite end parts emit light beams toward the light sources aligned along the other of the two opposite end parts.

3. The illumination device according to claim 1, wherein
the scattering means is scatterers respectively adhered to the side surfaces of the light guide.

4. The illumination device according to claim 1, wherein
the scattering means is microfabrication provided on the side surfaces of the light guide.

5. The illumination device according to claim 1, wherein
each of the light sources is a red light-emitting diode, a green light-emitting diode, or a blue light-emitting diode, and
the light sources are constituted by a combination of the red, green, and blue light-emitting diodes.

6. An illumination device comprising:
a plurality of light sources which emit light beams of two or more different colors; and
a plurality of light guides each of which mixes colored light beams emitted from the light sources and then converts the colored light beams thus mixed into surface emission, wherein
the plurality of light guides are arranged so as not to overlap one another,
each of the light guides has a plurality of concavities for arranging the plurality of light sources therein, the concavities being arranged along first end parts of each of the light guides, the plurality of light sources being placed in the concavities in a given order, and
scattering means for scattering light beams is provided in light source alignment areas and their vicinities on at least one of front and back surfaces of the light guide.

7. The illumination device according to claim 6, wherein
the plurality of light sources are aligned along the first end parts that are two opposite end parts of each of the light guides, and
the light sources aligned along one of the two opposite end parts emit light beams toward the light sources aligned along the other of the two opposite end parts.

8. The illumination device according to claim 6, wherein
the scattering means is scatterers adhered to at least one of the front and back surfaces of the light guide.

9. The illumination device according to claim 6, wherein
the scattering means is microfabrication provided on at least one of the front and back surfaces of the light guide.

10. The illumination device according to claim 6, wherein
each of the light sources is a red light-emitting diode, a green light-emitting diode, or a blue light-emitting diode, and
the light sources are constituted by a combination of the red, green, and blue light-emitting diodes.

11. An illumination device comprising:
a plurality of light sources which emit light beams of two or more different colors; and
a plurality of light guides each of which mixes colored light beams emitted from the light sources and then converts the colored light beams thus mixed into surface emission, wherein
the plurality of light guides are arranged so as not to overlap one another,
the plurality of light sources are aligned in a given order along first end parts of each of the light guides, and
side surfaces of second end parts of each of the light guide serve as absorption surfaces for absorbing light beams, the second end parts facing a direction along an array of the light sources.

12. The illumination device according to claim 11, wherein
the plurality of light sources are aligned along the first end parts that are two opposite end parts of each of the light guides, and
the light sources aligned along one of the two opposite end parts emit light beams toward the light sources aligned along the other of the two opposite end parts.

13. The illumination device according to claim 11, wherein
each of the light sources is a red light-emitting diode, a green light-emitting diode, or a blue light-emitting diode, and
the light sources are constituted by a combination of the red, green, and blue light-emitting diodes.

14. A liquid crystal display device comprising:
a liquid crystal display panel; and
a backlight for emitting light beams to the liquid crystal display panel, wherein
the backlight is an illumination device according to claim 1.

15. A liquid crystal display device comprising:
a liquid crystal display panel; and
a backlight for emitting light beams to the liquid crystal display panel, wherein
the backlight is an illumination device according to claim 6.

16. A liquid crystal display device comprising:
a liquid crystal display panel; and
a backlight for emitting light beams to the liquid crystal display panel, wherein
the backlight is an illumination device according to claim 11.
